(19) United States
(12) Patent Application Publication
(10) Pub. No.: US 2008/0243541 A1
(43) Pub. Date: Oct. 2, 2008

(54) System and method for recording medical information

(76) Inventors: Chris Felton, Menomonee Falls, WI (US); Patrick Greischar, Whitefish Bay, WI (US); Robert Hedgcock, Oconomowoc, WI (US)

Correspondence Address: CHRIS FELTON, W. 143 NORTH 5266 ST ANDREWS COURT, MENOMONEE, WI, 53703, US

(21) Appl. No.: 11/728,361

(22) Filed: Mar. 26, 2007

(51) Int. Cl. G06Q 50/00

(52) U.S. Cl. 705/2

(57) ABSTRACT

The present invention is directed to a digital pen and paper system for recording medical information. Medical information includes information about patients, their medical conditions, diagnoses, prescriptions and medical history. Medical information also includes information about evacuees and casualties of incidents such as medical emergencies, traffic and other accidents, natural and non-accidental disasters. This information may include personal information, demographic information and location information. The present invention also provides for recording medical information from incoming patients in hospitals and clinics.

### BACKGROUND OF THE INVENTION

1. Field of the Invention

The present invention relates generally to electronically recording handwritten information for triage tags. Further, the present invention relates to recording medical and patient information electronically in emergency and field situations.

2. Description of the Prior Art

Medical information of patients is usually recorded on paper. This information is then manually typed by a person on a computer. The time gap between recording the medical information and transferring it to a digital format is usually hours, if not days. During this time, the medical information may be required by doctors or medical professionals that are treating the patients. This information may also be changed, updated or amended. These changes are also recorded on paper and later uploaded to a digital medium.

The time delay in converting the hand written information to a digital format and making it available for the appropriate people increases as the number of patients in a medical facility increase. This time delay becomes critical during medical emergency situations, and mass causality incidents. During these conditions, medical facilities have to handle patients in large numbers. Recording patient information, conditions and treatments and then later converting those to a digital format becomes an enormous task. It may take days to get this enormous amount of information updated on a computer system. This time lag may adversely affect the treatment of patients.

During mass casualty incidents and emergencies, patient or evacuee information gets recorded on paper, similar to what has been described above. This information is useful in tracking patients. Unless this information is made widely available almost immediately and updated in realtime, tracking patients effectively may be difficult if not impossible.

Further, during accidents and other incidents where Emergency Medical Services (EMS) are required, the EMS personnel typically record information about victims on paper. This information is then handed to the medical personnel at the treating hospitals along with the victim. This practice does not provide sufficient time to the medical personnel to prepare for the incoming patients.

From the above discussion, it is clear that there is a need for a system to electronically capture patient and victim information so that it is available almost immediately to medical personnel to improve patient care and clinical outcomes. One such system is described in U.S. Pat. No. 6,686,910, titled “Combined writing instrument and digital documentor apparatus and method of use” by O'Donnell. This patent describes a handheld device that is used to create a hand written document and a digital copy of the hand written document. The device is constructed like a pen, but has digital and ink means combined so that hand written information is displayed on paper and is also captured in a digital format. The digital information is then transferred to a computer or a similar device.

Another such system is described in US Patent Application Publication No. 20060159345 titled “System and method for associating handwritten information with one or more objects” by Clary, et. al. This patent application describes the use of a unique identifier with a digital paper so that the unique identifier can be associated with the information that is captured on the digital paper. The identifier can be a barcode or even a radio frequency identification (RFID) tag. This patent application describes enabling the digital pen device to prompt the user operating the device during multiple steps in its operation. The digital pen captures hand written information and associates the hand written information with the unique identifier that is present on the paper on which the information is written.

Although the above mentioned patent and patent applications describe the use of a digital pen and paper to record hand written information, there is still a need for a system that captures hand written information for medical purposes. The system should be robust for use in the field during medical emergencies, mass casualty incidents and accidents. The system should capture patient medical information and transmit it in near real-time to a central computer for further processing or delivery to the appropriate recipients. Additionally, the system should be able to identify a patient record by a unique identifier present on the digital paper so that any changes to the patient record are automatically associated with the individual patient's electronic record.

### SUMMARY OF THE INVENTION

A first aspect of the present invention is to provide a system for recording medical information comprising a digital pen for recording hand written medical information, a digital paper for enabling the digital pen to record handwritten information, and a central information store for receiving medical information transmitted by the digital pen and storing the medical information.

A second aspect of the present invention is to provide a method for recording medical information comprising the steps of using a digital pen and digital paper to hand write medical information, identifying the digital paper and a template used by the digital paper, digitally interpreting hand written information recorded on the digital paper, and transmitting the hand written information to a central information store.

The present invention is further directed to a method for enabling recording of medical information on a digital paper so that the recorded information is converted into an electronic format at the time of it being recorded on paper.

Thus, the present invention provides a digital pen and paper system that records information such as that on triage tags, patient medical forms, patient history forms, emergency forms, forms required to be filled in by those persons who are evacuated, moved or injured. It is also provides for recording information from volunteers, red cross personnel and the like.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is an overall schematic of the system, in accordance with an embodiment of the present invention.

FIG. 2 is an overall schematic of the system, in accordance with an embodiment of the present invention.

FIG. 3 is a schematic of a digital paper, in accordance with an embodiment of the present invention.

FIG. 4 is an exemplary medical form template in accordance with an embodiment of the present invention.

FIG. 5 is an exemplary medical form template in accordance with an embodiment of the present invention.

FIG. 6 is a flowchart of the steps for recording hand written medical information, in accordance with an embodiment of the present invention.

FIG. 7 is an exemplary screen view of information fields in volunteer credential form template, in accordance with an embodiment of the present invention.

FIG. 8 is an exemplary screen view of information fields in volunteer credential form template, in accordance with an embodiment of the present invention.

### DETAILED DESCRIPTION

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

The present invention is directed to a digital pen and paper system for recording medical information. Medical information includes information about patients, their medical conditions, diagnoses, prescriptions and medical history. Medical information also includes information about evacuees and casualties of incidents such as medical emergencies, traffic and other accidents, and natural or non-accidental disasters. This information may include personal information, demographic information and location information. The present invention also provides for recording medical information from incoming patients in hospitals and clinics.

The present invention comprises a digital pen and paper system. Medical information from one or the above listed situations is recorded on the digital paper using the digital pen by medical personnel attending to the patients or those injured. Medical forms are printed on the digital paper so that they resemble the normal medical forms that are currently used on conventional paper. Each sheet of digital paper also contains a unique identifier imprinted or embedded on it. The unique identifier can be a barcode, a radio frequency identification (RFID) tag, or other machine readable means of identification. Unique Identifier can be used to uniquely identify more than one attribute of the digital paper. For example, it can uniquely identify each sheet of paper by a serial number and it can uniquely identify the form template printed on the digital sheet. These two functions can be carried out by one or more identifiers. One identifier that is a combination of two number and/or letter combinations can be used. Alternatively, two separate identifiers can also be used. Thirdly, one unique number can be used and based on a predefined algorithm, the digital pen can then identify the two identifiers by just using a single identifier. It will be apparent to one skilled in the art that there are many different ways to incorporate one or more unique identifiers on a piece of paper and they have been omitted to the sake of conciseness.

The unique identification tags on the digital paper are identifiable by the digital pen. The digital pen is used to hand write medical information on the digital paper. The digital pen identifies the forms printed on the digital paper by the unique identifier on the digital paper. The digital pen records information written on the digital paper and transmits it to an intermediate information transmitting device, such as a docking station. Other examples of the intermediate information transmitting device include a PDA, cell phone, laptop computer, desktop computer and other mobile computing devices that are programmable and capable to communicate with the digital pen to exchange information and data. The digital pen transmits the recorded medical information intermediate information transmitting device using wireless communication or wired communication. The digital pen can also transmit the recorded information to the docking station when it is physically docked with the docking station.

The intermediate information transmitting device then transmits the hand written information to a central information store. The information store is a central database that stores medical information for a plurality of patients. The information store has the capabilities to collect information from such multiple intermediate information transmitting devices. The information store and distribute this collected information to various other databases and systems. The intermediate information transmitting device can transmit the medical information to the central information store via a network, the internet, wireless means such as cellular networks, Bluetooth, WiFi, etc.

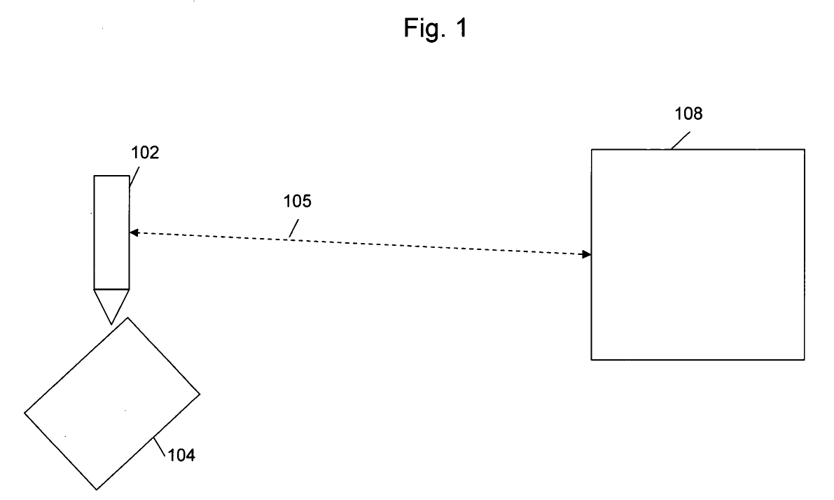

Referring now to the drawings in general, the illustrations are for the purpose of describing a preferred embodiment of the invention and are not intended to limit the invention thereto. As best seen in FIG. 1, an overall system of the present invention is shown comprising a digital pen 102, a digital paper 104, link 105 and a central information store 108. Digital pen 102 has sensing means known in the art to sense hand written information written on digital paper 104 and convert it to digital form. The digital form is an electronic document that mirrors information on digital paper 104. Digital paper 104 has some pre-printed information such as fields that are to be filled in. When these fields are completed by writing on paper 104 by pen 102, the pen converts all hand written information into an electronic document and stores the document on its memory. In one embodiment, pen 102 can instantaneously transmit the document to central information store 108 via link 105. Link 105 connects two device by wireless means such as Bluetooth, infrared, 802.11, cellular network, and other means. In an alternate embodiment, pen 102 transmits the document with pen 102 is physically connected to central information store 108. Central information store 108 acts as a physical dock and can receive one or more documents stored in the memory of pen 102. In yet another embodiment, pen 102 can be connected to central information store 108 by wired means such as a universal serial bus cable connect, serial or parallel port cable connects and others, depicted as link 105. In other embodiments, pen 102 transmits documents to central information store 108 at regular intervals. Central information store receives documents on pen 102. Central information store 108 can store these documents and combine documents for the same patient into a patient medical record. Central information store 108 is a database that has the ability to provide access to authorized personnel to view or change the stored medical records.

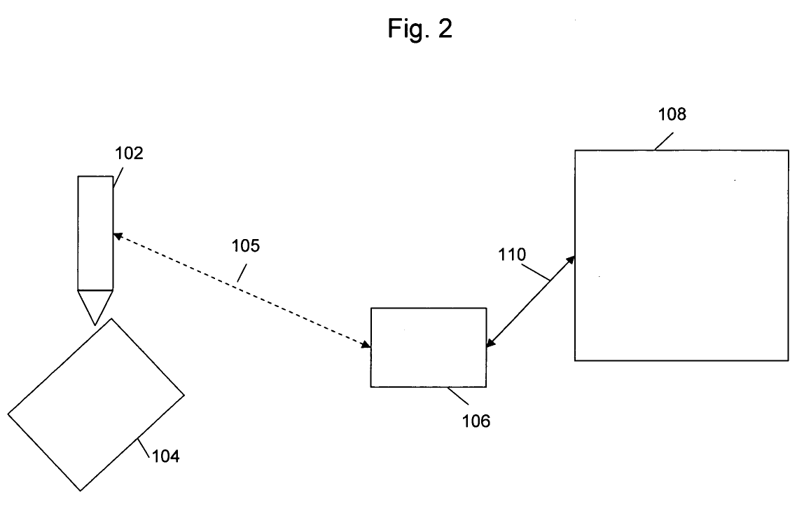

FIG. 2 is an overall schematic of the system, in accordance with an embodiment of the present invention. In one embodiment, pen 102 can instantaneously transmit the document to intermediate information transmitting device 106 via wireless means such as Bluetooth, infrared, 802.11, cellular network, and other means, depicted as link 105. In an alternate embodiment, pen 102 transmits the document with pen 102 is physically connected to intermediate device 106. Intermediate device 106 acts as a physical dock and can receive one or more documents stored in the memory of pen 102. In yet another embodiment, pen 102 can be connected to intermediate device 106 by wired means such as a universal serial bus cable connect, serial or parallel port cable connects and others. In other embodiments, pen 102 transmits documents to intermediate device 106 at regular intervals.

Intermediate device 106 connects with a central information store 108 via a network 110. Central information store receives documents on intermediate device 106. Intermediate device 106 connects with central information store 108 via network 110. Network 110 can be a local network, the internet, wireless network, cellular network or a dialup network. In a second embodiment, intermediate device 106 can connect with other intermediate devices. Intermediate device 106 can connect to central store 108 instantaneously to transmit documents received by intermediate device 106 from pen 102, or can connect at regular intervals to send the received documents to central store 108. In yet another embodiment, pen 102 and intermediate device 106 are contained in a single housing and are one physical entity. Hence, pen 102 as a whole can connect with central information store 108 over network 110.

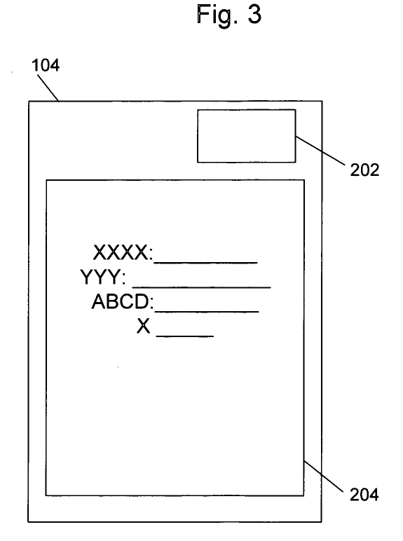

FIG. 3 is a schematic of a digital paper, in accordance with an embodiment of the present invention. Digital paper 104 contains unique identifier 202 and a medical form template 204. Medical form template 204 is printed on the surface of paper 204. Identifier 202 can also be printed on the surface of paper 104 in the form of a barcode. In another embodiment, identifier 202 can be embedded within the surface of paper 104. This could mean using a RFID tag that is embedded in each sheet of digital paper. Identifier 202 enables pen 102 to identify the template 204 that is printed on paper 104. Template 204 is selected from a list of templates that have been previously defined with pen 102. Template 204 includes templates for triage tags, daily patient tags, patient care records and forms, Red Cross forms, patient intake forms, immunization forms, medical intervention forms, credential and volunteer forms that are used conventionally as normal paper based forms. A credential form is used to record information from a licensed medical professional, such as a doctor, nurse, etc. A part of the information that is recorded on the credential form needs to be verified, such as license information. Volunteer forms are used to record information from people who want to volunteer and without having any specialized skills for the volunteer job. Medical intervention forms are used to record interventions such as antibiotics prescribed to patients, quarantined patients and other medical interventional procedures that affect patients or evacuees.

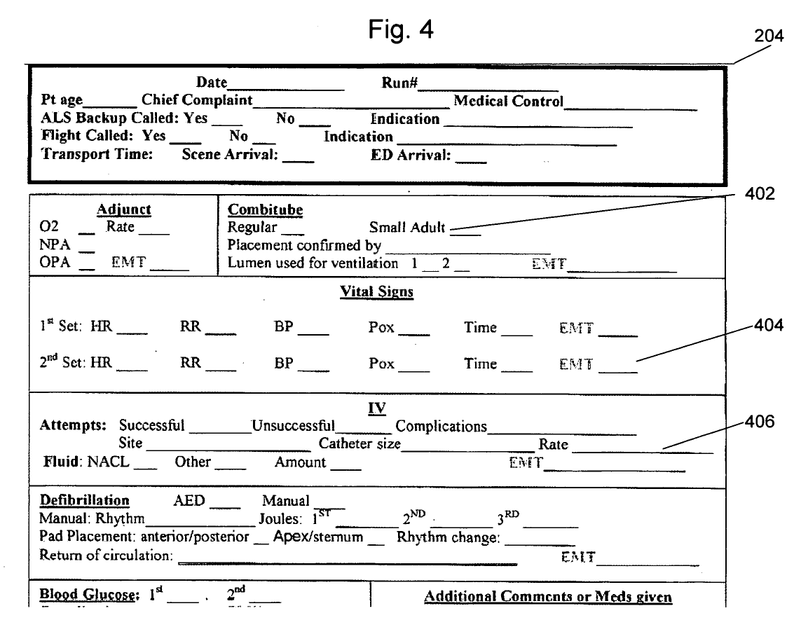

FIG. 4 is an exemplary medical form template in accordance with an embodiment of the present invention. It shows medical form template 204. Medical form template 204 consists of information fields 402, 404 and 406. Information field 402 is of type check box. Input for this field is typically a check mark or a cross mark. Information fields 404 and 406 require text and numerical input. Input in these fields is recorded by digital pen 102. The text based input is then converted into digital form and transmitted to central information store 108.

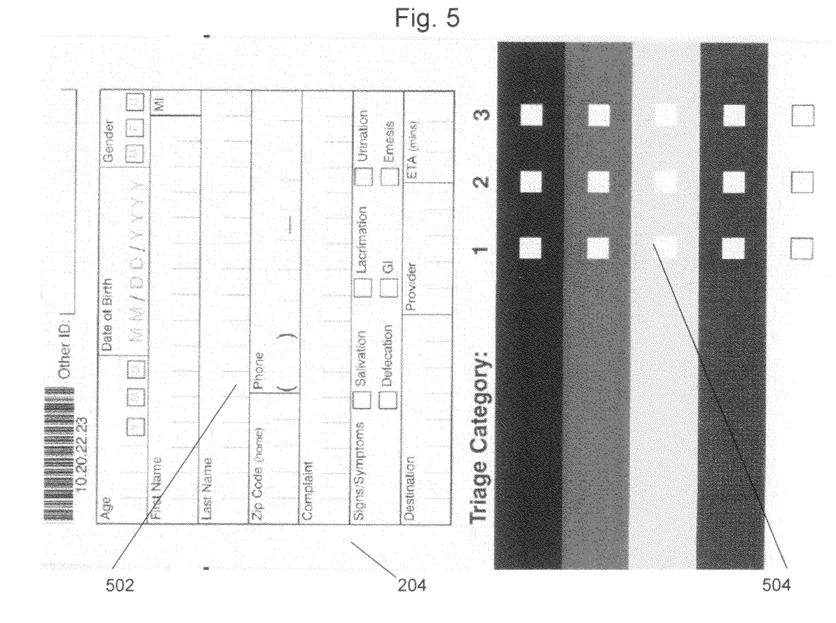

FIG. 5 is an exemplary medical form template in accordance with an embodiment of the present invention. It shows medical form template 204 which is a triage tag. Medical form template 204 comprises information fields 502 and 504. Information fields 502 require text input and information fields 504 require inputs that are check marks or crosses. These inputs are provided as hand written input using digital pen 102. Digital pen also converts the hand written input into digital format and transmits it to central information store 108.

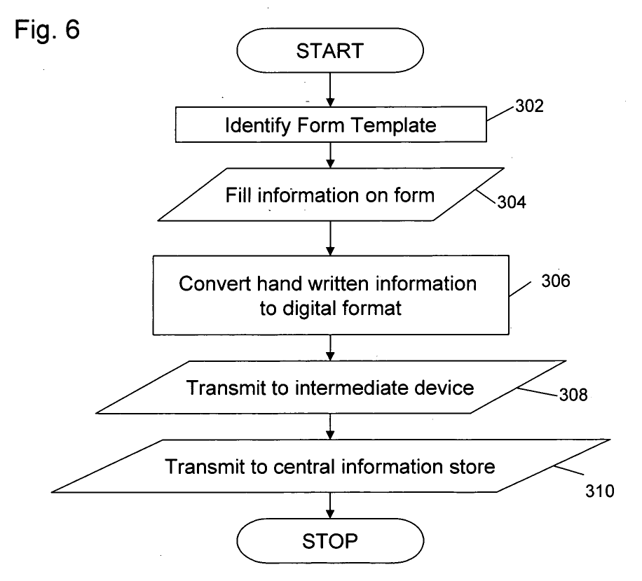

FIG. 6 is a flowchart of the steps for recording hand written medical information, in accordance with an embodiment of the present invention. First, at step 302, the template printed on paper 104 is correctly identified by reading and interpreting the identifier 202 on paper 104. Then a person using pen 102 writes information on paper 104 based on the template 204 on paper 104, at step 304. Pen 102 has ink so that as the person moves the pen over paper, ink flows and is transferred to the paper to show the written information, similar to a conventional pen. Pen 102 also has the ability to interpret the hand written information on paper 104 into a digital format, which is commonly known in the art. This is depicted at step 306. After all the handwritten information is converted into a digital format and stored in the pen's memory, the information is transmitted to intermediate device 106 at step 308. Pen 102 can also store the information in its memory and transmit it at a later point based on predefined settings that are stored in the pen. Intermediate device 106 collects information from the pen and transmits it to central information store 108 at step 310.

In a preferred embodiment, pen 102 is used with a triage tag that is printed on digital paper 104. Medical personnel use pen 102 to record triage information on digital paper 104. This information is then converted to a digital format and transmitted to a central information store 108. The central information store can then track changes and updates to the triage tag for each patient stored in the system. This enables the ability of the medical facility to provide up to date information about the patient to the personnel requiring such information without having a long paper trail. When pen 102 is used with a triage tag, pen 102 recognizes the triage tag template by reading the unique identifier 202 present on paper 104. In an embodiment, unique identifier 202 is a combination of numbers and letters, a part of which identifies the template used. The entire number letter sequence is unique so as to uniquely identify triage tags of different patients. When changes are made on the same triage tag sheet, digital pen 102 uses the unique identifier and transmits the changes to central information store 108. Central information store 108 uses the unique identifier to correctly identify the record of the patient whose triage tag has been updated. An exemplary triage tag is depicted in FIG. 5.

By using digital pen 102, the hand written is available in a digital format without any time delay that is associated with conventional pen and paper based systems. The use of digital pen and paper also eliminates any errors that may occur during the conversion of hand written records.

In an alternate embodiment, pen 102 is used to record medical information and other details of people injured or affected by emergencies such as natural disasters, mass causality incidents or where a large number of people are evacuated or removed. Pen 102 is used to record their demographic information and location information, including current location, destination and estimated time of arrival. Such information is then transmitted to central information store 108 via intermediate device 106. Central information store 108 collects similar information from a multiple evacuees. It then provides this information to personnel responsible for managing the emergency event affecting the evacuees. The people can then disseminate this information to medical authorities and relatives and friends trying to track the evacuees. The use of digital pen 102 makes such information easily and readily available without having large expensive computing equipment available on the site of the emergency. In an alternate embodiment, the system of the present invention is used in shelters to track evacuees and record their medical conditions.

In another embodiment, the system of the present invention is used by EMS personnel. EMS personnel use pen 102 to record medical status and injuries to people in accidents or patients that require medical services. This information is recorded and instantaneously transmitted to information store 108 in the medical facility receiving the patients. This information is useful to the medical facility to prepare medications and equipment/rooms to suitable treat the patient. In case a conventional pen and paper system was used by the EMS personnel, this information would not have been available to the medical personnel at the facility until the patient physically arrived at the facility along with the hand written medical record. An exemplary EMS emergency form is shown in FIG. 4.

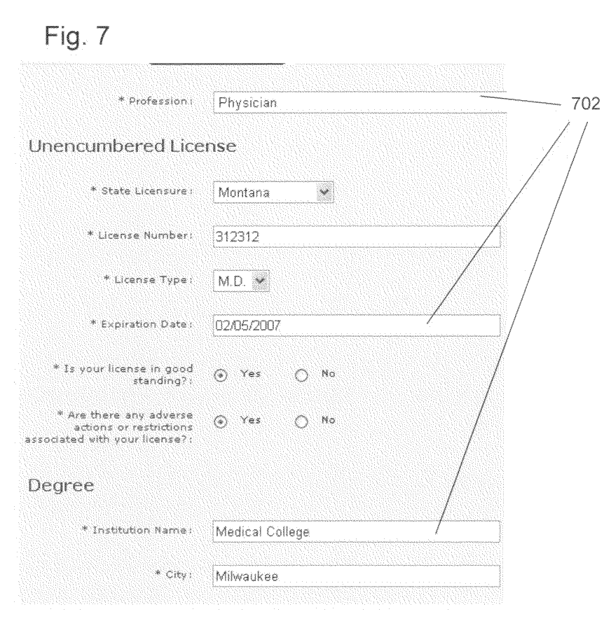

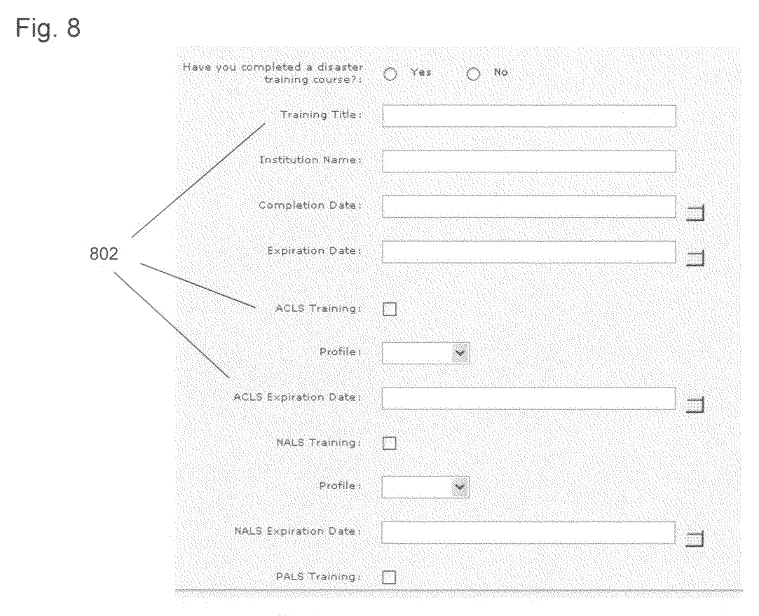

In yet another embodiment, the present invention is used at site of medical emergencies and mass casualty incidents to register volunteers. Volunteer use pen 102 to fill in their personal and professional information. This information is instantaneously transmitted to a central information store to verify to accuracy. Once the information is verified by the central information store, the volunteer can be allowed access to the emergency and help the victims. The level of access allowed to the volunteer can be determined on the basis of the credentials of the volunteer. For example, if the volunteer is a surgeon then the volunteer should be allowed to treat the injured. Paper 104 is used to record volunteer credentials and these are then transmitted to central store that verifies the correct credentials and generates a credential score or level for the volunteer. Volunteer credential form includes fields such as demographic information, medical license number, encumbered (yes or no), place of practice (city, state, etc), place of degree (college, state), specialty (pathology, surgery, orthopedic, etc), certifications, affiliations, recognitions for professional organizations, level of participation, duration of participation in event, certified to practice at locations (for doctors or nurses) and the like. FIG. 7 and FIG. 8 show exemplary screen views of information fields for credential forms, as discussed above. These fields, 702 and 802, show information recorded using the digital pen and paper system of the current invention.

Certain modifications and improvements will occur to those skilled in the art upon a reading of the foregoing description. By way of example, digital pen 102 can be used without using intermediate information transmitting device 106 or by combining them both into a single physical entity. Also, templates for medical form 204 can also include templates for forms used in day to day medical activities such as patient check ins, diagnosis and treatments for patients at medical facilities, prescriptions for patients and Red Cross volunteer forms. Additionally, the central information store can gather information from one or more medical facilities using the digital pen and paper system of the present invention. The above mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the following claims.

What is claimed is:

1. A system for recording medical information comprising:
a. a digital pen for recording hand written medical information,
b. a digital paper for enabling the digital pen to record handwritten information,
c. a central information store for receiving medical information transmitted by the digital pen and storing the medical information.

2. The system of claim 1, further comprising an intermediate information transmitting device for receiving the medical information recorded by the digital pen and transmitting it to the central information store.

3. The system of claim 1, wherein the digital paper is designed as a template for recording specific medical information.

4. The system of claim 3, wherein the template for specific medical information is selected from the group consisting a triage tag, a daily medical tag, patient care record, red cross record, patient intake form, medical personnel credential form, emergency medical care form, and volunteer information form, immunization form, medical intervention form.

5. The system of claim 1, wherein the digital paper has at least one unique identifier that is readable by the digital pen.

6. The system of claim 5, wherein the digital pen recognizes the unique identifier on the digital paper.

7. The system of claim 1, wherein the digital pen transmits the handwritten information to the intermediate information transmitting device.

8. The system of claim 3, wherein the template further comprises personal, demographic and location information.

9. The system of claim 8, wherein the central information store utilizes medical information to track evacuees of emergencies and medical events.

10. A method for recording medical information comprising the steps of:
a. using a digital pen and digital paper to hand write medical information,
b. identifying the digital paper and a template used by the digital paper,
c. digitally interpreting hand written information recorded on the digital paper, and
d. transmitting the hand written information to a central information store.

11. The method of claim 10, further comprising the step of transmitting the medical information to an intermediate information transmitting device, the intermediate information transmitting device then transmitting the medical information to a central information store.

12. The method of claim 11, wherein the central information store is a medical facility.

13. The method of claim 10, wherein the medical information is recorded from at least one patient in an accident.

14. The method of claim 10, wherein the medical information is recorded from at least one patient in a mass casualty incident.

15. The method of claim 10, wherein the medical information is recorded from at least one patient in an emergency.

16. The method of claim 10, further comprising the step of recording personal, demographic and location information.

17. The method of claim 16, wherein the personal and location information is used to track at least one victim in a mass medical event and emergency situation.

18. The method of claim 10, wherein the medical information is recorded from volunteers at site of a medical emergency and mass medical event to verify credentials of the volunteers.
